(19) United States
(12) Patent Application Publication
(10) Pub. No.: US 2026/0145587 A1
(43) Pub. Date: May 28, 2026

(54) GEAR DEVICE FOR VEHICLE SEAT

(71) Applicant: TOYOTA BOSHOKU KABUSHIKI KAISHA, Aichi (JP)

(72) Inventors: Wataru SAKAGUCHI, Nagoya-shi (JP); Masashi HATTORI, Seto-shi (JP)

(73) Assignee: TOYOTA BOSHOKU KABUSHIKI KAISHA, Aichi (JP)

(21) Appl. No.: 19/394,189

(22) Filed: Nov. 19, 2025

(30) Foreign Application Priority Data
Nov. 28, 2024 (JP) 2024-207350

(51) Int. Cl. B60N 2/02; B60N 2/225; F16H 1/32

(52) U.S. Cl. CPC B60N 2/02253; B60N 2/2251; F16H 1/32

(57) ABSTRACT

In a gear device, a sliding contact portion capable of making a sliding contact with only a part of a side surface of a planetary gear is provided on a side opposite a holder of the planetary gear with the planetary gear interposed between the sliding contact portion and the holder.

### CROSS-REFERENCE TO RELATED APPLICATIONS

This application claims the benefit of priority based on Japanese patent application No. 2024-207350 filed on November 28, 2024 with the Japan Patent Office, and the entire disclosure of Japanese patent application No. 2024-207350 is incorporated herein by reference.

### BACKGROUND

The present disclosure relates to a gear device that transmits a rotational force to a movable portion of a vehicle seat.

For example, a planetary gear device disclosed in Unexamined Japanese Patent Application Publication No 2022-88151 includes a sun gear, an internal gear, planetary gears in mesh with the sun gear and the internal gear, and carrier plates (also referred to as “holders”) holding the planetary gear. Annular protrusions are provided on inner peripheral sides of contact surfaces in side surfaces of the planetary gears in contact with the carrier plates.

### SUMMARY

When a thrust bearing, which makes a sliding contact with the entire area of an axial end surface of the gear, is provided to limit a load and/or restrict displacement of the gear in an axial direction (also referred to as a "thrust direction"), rotational resistance may increase. In view of this point, the present disclosure discloses an example of a gear device capable of inhibiting an increase in rotational resistance.

A gear device configured to transmit a rotational force to a movable part of a vehicle seat according to one aspect of the present disclosure preferably includes at least one of the following constituent elements.

That is, the constituent elements include: a sun gear configured to receive a driving force from an electric motor; a planetary gear configured to revolve and orbit around the sun gear while rotating in mesh with the sun gear; a holder supporting the planetary gear to allow rotation of the planetary gear and revolution of the planetary gear around the sun gear, the holder being arranged rotatably and coaxially with a rotation center axis of the sun gear; an output shaft configured to receive a rotational force from the holder to thereby rotate; an internal gear in mesh with the planetary gear; and a sliding contact portion that is arranged on a side opposite the holder with the planetary gear interposed between the sliding contact portion and the holder and that is capable of making a sliding contact with only a part of a side surface of the planetary gear, the sliding contact portion having an annular shape centered on the rotation center axis of the sun gear.

This allows the sliding contact portion of the gear device to function as a thrust bearing that inhibits the planetary gear from displacing in the axial direction. Since the sliding contact portion is capable of making a sliding contact with only a part of the side surface of the planetary gear, the gear device may have lower rotational resistance of the planetary gear than a configuration in which the sliding contact portion is in contact with the entire side surface of the planetary gear does.

The gear device may also have the following configuration.

That is, it is desirable that the planetary gear includes a boss that is provided on a side opposite the holder and that protrudes toward a sliding contact portion side with a center axis of the boss coinciding with a rotation center axis of the planetary gear, wherein the sliding contact portion is capable of making a sliding contact with only a part of a tip surface of the boss. It is desirable that the sliding contact portion is formed as an elongated protrusion protruding toward a planetary gear side.

It is desirable that the holder includes a shaft portion having a protruding shape and fitting into a shaft hole provided at a center of rotation of the planetary gear, and furthermore, the planetary gear is inhibited from falling off the shaft portion in a state of being held between the holder and the sliding contact portion.

It is desirable that the sliding contact portion is formed to include at least a first elongated protrusion and a second elongated protrusion that are arranged concentrically, and furthermore, the first elongated protrusion is positioned on a side opposite the second elongated protrusion with a trajectory interposed between the first elongated protrusion and the second elongated protrusion, the trajectory being traced by the center of rotation of the planetary gear. As a result, in the gear device, it is possible to restrict a significant inclination of a posture of the planetary gear.

It is also desirable that the gear device includes a worm configured to be rotationally driven by an electric motor and a worm wheel in mesh with the worm, the worm wheel being arranged coaxially with the sun gear and connected to the sun gear, wherein the sliding contact portion is provided on a side surface of the worm wheel.

In the gear device, the rotation directions of the worm wheel and the planetary gear are opposite. That is, when a virtual circle is defined as a circle that is centered on a center of revolution (orbit), i.e., a center of rotation of the sun gear, and that passes through the center of rotation of the planetary gear, the relative velocity of the planetary gear with respect to the sliding contact portion differs significantly between one side and the other side, with the virtual circle interposed therebetween.

Regarding this, the sliding contact portion of the gear device is capable of making a sliding contact with only a part of the side surface of the planetary gear. Therefore, compared to a configuration in which the entire side surface of the planetary gear is in sliding contact with the side surface of the worm wheel, the rotational resistance of the planetary gear can be reduced.

### BRIEF DESCRIPTION OF THE DRAWINGS

Several embodiments of the present disclosure will be described hereinafter by way of example with reference to the accompanying drawings, in which:

FIG. 1 is a diagram showing an electric actuator according to a first embodiment;

FIG. 2 is a diagram showing a structure of a gear device according to the first embodiment;

FIG. 3 is a diagram showing a structure of the gear device according to the first embodiment;

FIG. 4 is a diagram showing a structure of the gear device according to the first embodiment;

FIG. 5 is a diagram showing a structure of the gear device according to the first embodiment;

FIG. 6 is a diagram showing a structure of the gear device according to the first embodiment; and

FIG. 7 is a diagram showing a worm wheel according to the first embodiment.

### DETAILED DESCRIPTION OF EXEMPLARY EMBODIMENTS

The following embodiment of the invention is an example of embodiments that belong to the technical scope of the present disclosure. In other words, matters specifying the invention recited in the claims are not limited to the specific configurations or structures shown in the following embodiment.

The present embodiment is an example in which a gear device for a vehicle seat (hereinafter referred to as "gear device") of the present disclosure is applied to a seat (hereinafter referred to as "vehicle seat") mounted in a vehicle such as an automobile. Hatched lines and the like in the figures are provided for easier understanding of the relationships among the figures and the shapes of the members or portions.

The direction of the gear device is not limited to directions shown in the figures. The directions shown in the figures are directions in a state where the vehicle seat of the present embodiment is assembled to a vehicle. The figures with hatched lines do not necessarily show cross-sectional views.

With respect to members or portions at least described with reference numerals, at least one of them is provided unless otherwise specified by terms such as “only one”. In other words, unless it is expressly stated as “only one” or the like, two or more of the members may be provided. The gear device disclosed herein includes at least one of components, such as members or portions described at least with reference numerals, and structural portions illustrated in the figures.

### First Embodiment

### 1. Overview of Gear Device

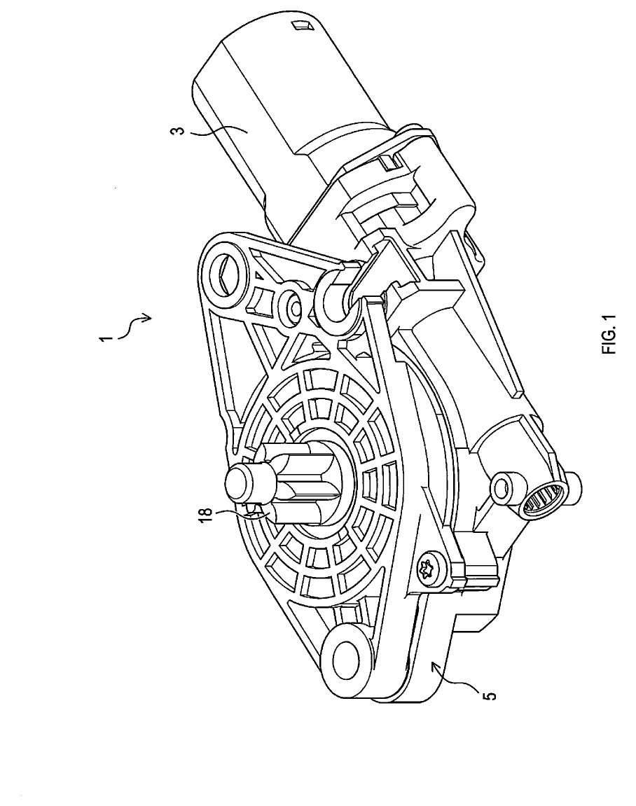

The gear device of the present embodiment is applied to an electric actuator 1 shown in FIG. 1. The electric actuator 1 has a configuration in which an electric motor 3 and a gear device 5 are integrated. The electric motor 3 is a driving source that generates a rotational force.

The gear device 5 according to the present embodiment is configured as a decelerator. The gear device 5 reduces a rotational speed of the electric motor 3 and transmits a rotational force to a movable portion of a vehicle seat. Examples of the movable portion of the vehicle seat include, for example, a lifter link that lifts and lowers a seat body and a tilt arm that lifts and lowers a front-end portion of a seat cushion.

### 2. General Configuration of Gear Device

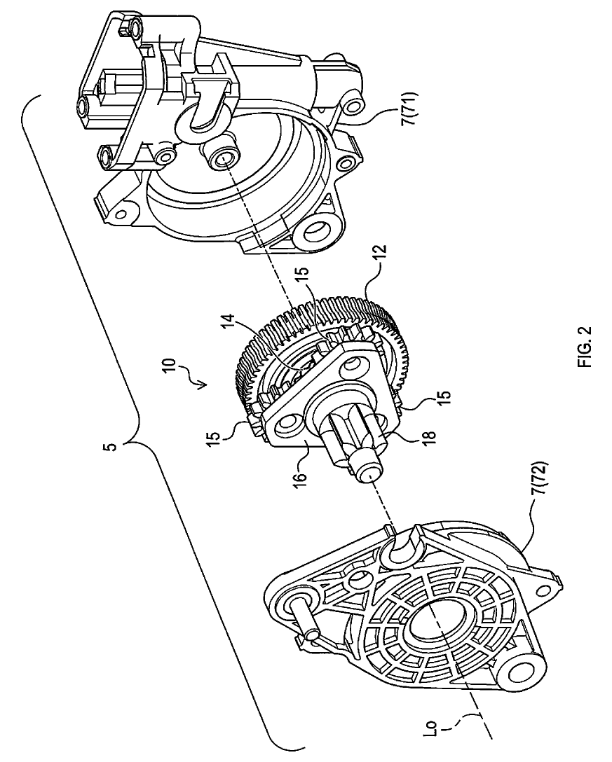

The gear device 5 includes, as shown in FIG. 2, a gear casing 7 and a gear mechanism 10. The gear casing 7 is a casing that houses the gear mechanism 10. The electric motor 3 is fixed to the gear casing 7 by bolts (not shown).

The gear casing 7 includes at least a casing body 71 and a casing cover 72. The casing body 71 and the casing cover 72 are fastened and fixed to each other by two or more bolts (two bolts in the present embodiment), which are not shown.

### 2.1 Configuration of Gear Mechanism

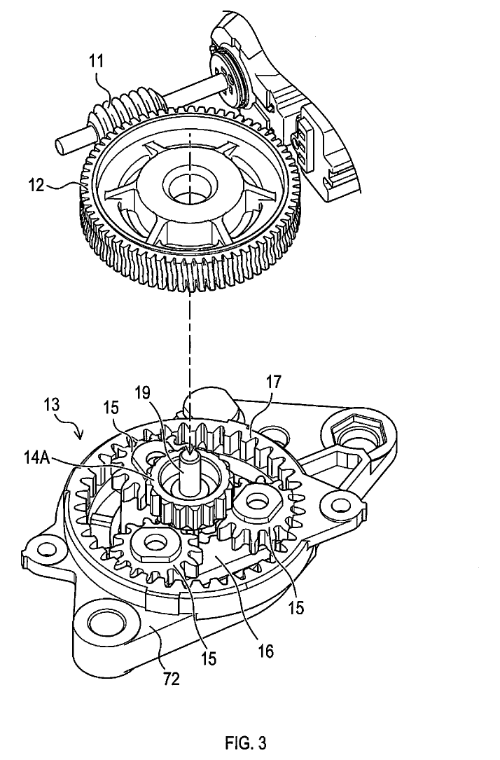

The gear mechanism 10 includes, as shown in FIG. 3, at least a worm 11, a worm wheel 12, a planetary gear mechanism 13 and so on. The worm 11 is a gear shaped like a male screw and is fixed to an output shaft (not shown) of the electric motor 3.

The worm wheel 12 is a gear that meshes with the worm 11 and rotates. Note that the worm wheel 12 is configured as a helical gear in which tooth trace is inclined relative to a rotation center axis Lo (see FIG. 2).

### Planetary Gear Mechanism

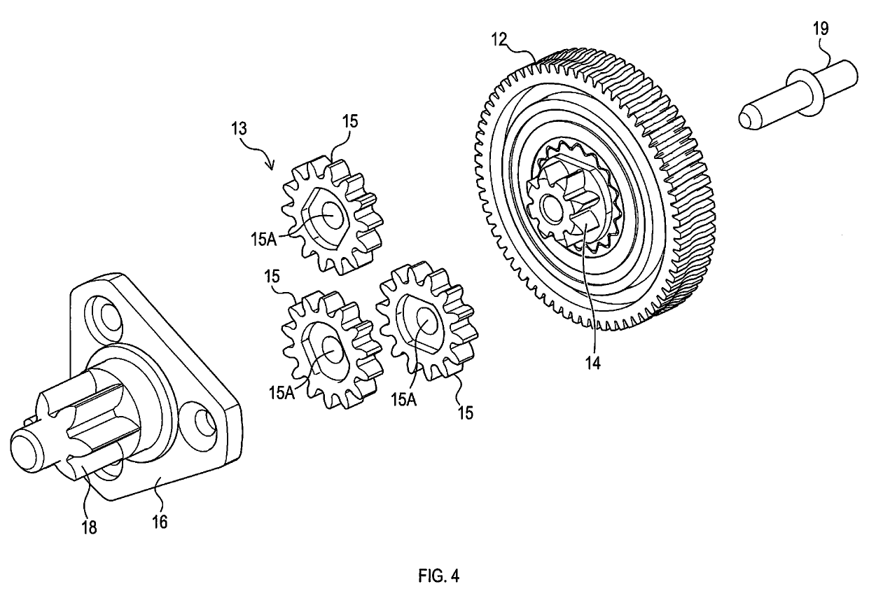

The planetary gear mechanism 13 includes, as shown in FIG. 4, at least a sun gear 14, planetary gears 15, a holder 16, and an internal gear 17 (see FIG. 3). The sun gear 14 is a gear configured to receive a driving force from the electric motor 3.

Specifically, the sun gear 14 is coaxially arranged with the worm wheel 12 and connected to the worm wheel 12. Therefore, the sun gear 14 rotates integrally with the worm wheel 12.

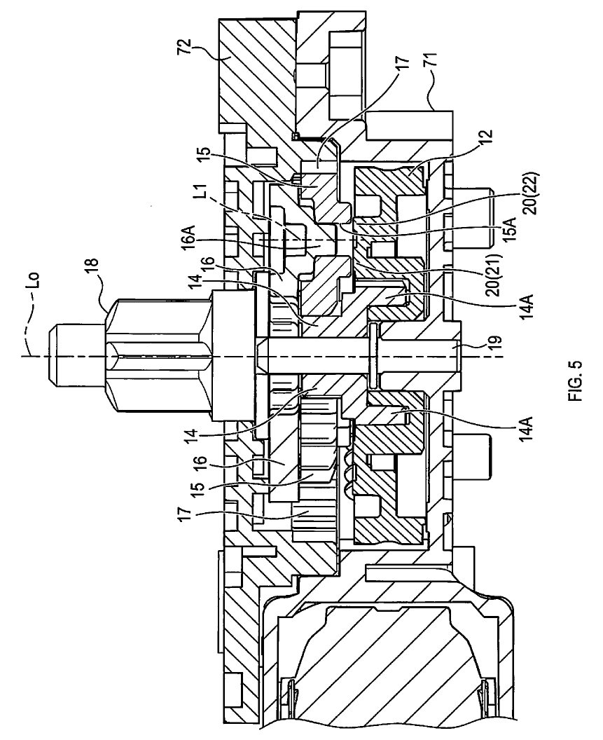

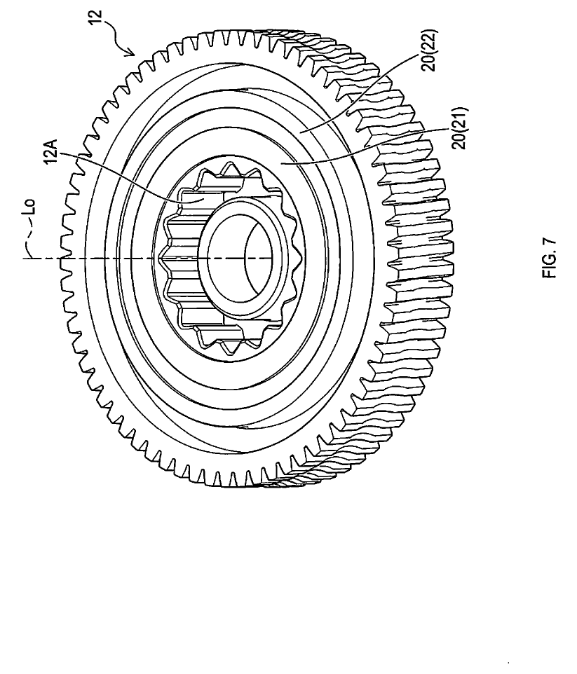

As shown in FIG. 5, the sun gear 14 is provided with an engagement portion 14A that engages with the worm wheel 12. The engagement portion 14A fits into an engagement hole 12A (see FIG. 7) of the worm wheel 12.

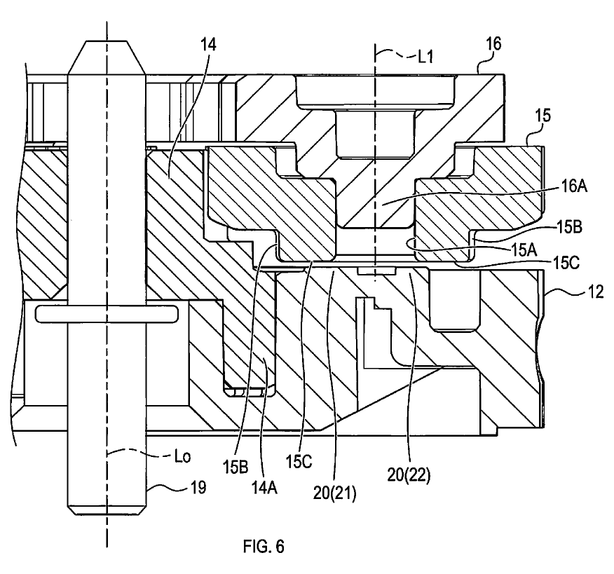

The worm wheel 12 and the sun gear 14 are rotatably supported by a revolution shaft 19. The revolution shaft 19 is supported by and fixed to the casing body 71. Note that the engagement portion 14A and the engagement hole 12A according to the present embodiment are formed in gear-like shapes (see FIGS. 3 and 6).

As shown in FIGS. 3 to 5, each of the planetary gears 15 is a gear that revolves and orbits around the sun gear 14 while rotating in mesh with the sun gear 14. In the present embodiment, two or more (specifically, three) planetary gears 15 are provided.

The three planetary gears 15 are all congruent. Therefore, when the term "planetary gear 15" is simply used hereinafter, it refers to either the three planetary gears 15 collectively or any one of the planetary gears 15.

The holder 16 is a carrier that supports the planetary gear 15 such that the planetary gear 15 can rotate and the planetary gear 15 can revolve around the sun gear 14. The holder 16 is arranged rotatably and coaxially with the rotation center axis Lo of the sun gear 14.

As shown in FIG. 5, the planetary gear 15 includes a shaft hole 15A at its center of rotation. The shaft hole 15A is a through hole that passes through the planetary gear 15 along a rotation center axis L1 of the planetary gear 15. The holder 16 includes a shaft portion 16A having a protruding shape and fitting into the shaft hole 15A.

With this configuration, the planetary gear 15 can revolve and orbit around the rotation center axis Lo of the sun gear 14 while rotating around the rotation center axis L1. The holder 16 includes an output shaft 18 (see FIG. 4). This allows the output shaft 18 to receive a rotational force from the holder 16 and rotate.

The internal gear 17 is a ring-shaped gear in mesh with the planetary gears 15, as shown in FIG. 3. The internal gear 17 of this embodiment is integrally formed with an inner wall of the casing cover 72 and configured as a component integrated with the casing cover 72.

### Support Structure of Planetary Gear

As shown in FIG. 6, a sliding contact portion 20 is provided on a side opposite the holder 16 with the planetary gear 15 interposed therebetween. The sliding contact portion 20 is a portion capable of making a sliding contact with only a part of a side surface of the planetary gear 15. The sliding contact portion 20 is formed in an annular shape centered on the rotation center axis Lo of the sun gear 14 (see FIG. 7).

That is, the planetary gear 15 includes a boss 15B on the side opposite the holder 16 (a lower side of the planetary gear 15 in FIG. 6). The boss 15B is a cylindrical protrusion protruding toward a sliding contact portion 20 side (downward in FIG. 6). Note that a central axis of the boss 15B coincides with the rotation center axis L1 of the planetary gear 15.

The sliding contact portion 20 is capable of making a sliding contact with only a part of a tip surface 15C of the boss 15B (in FIG. 6, a lower end surface of the boss 15B). The sliding contact portion 20 of this embodiment is formed as an elongated protrusion protruding toward a planetary gear 15 side.

Specifically, the sliding contact portion 20 is formed to include at least a first elongated protrusion 21 and a second elongated protrusion 22 that are arranged concentrically (see FIG. 7). The first elongated protrusion 21 is positioned on a side opposite the second elongated protrusion 22 with a trajectory interposed therebetween, the trajectory being traced by a center of rotation of the planetary gear 15.

Note that the "trajectory traced by a center of rotation of the planetary gear 15" refers to a circle that passes through the center of rotation of the planetary gear and that is centered on the center of rotation of the sun gear 14. The first elongated protrusion 21 is located inside the circle, and the second elongated protrusion 22 is located outside the circle.

As shown in FIG. 6, the planetary gear 15 is inhibited from falling off the shaft portion 16A of the holder 16 in a state of being held between the holder 16 and the sliding contact portion 20. The sliding contact portion 20 of this embodiment is provided on a side surface of the worm wheel 12, as shown in FIG. 7.

### 3. Features of Gear Device of Present Embodiment

The sliding contact portion 20 capable of making a sliding contact with only a part of the side surface of the planetary gear 15 is provided on the side opposite the holder 16 with the planetary gear 15 interposed therebetween. This allows the sliding contact portion 20 of the gear device 5 to function as a thrust bearing that restricts displacement of the planetary gear 15 in an axial direction.

Since the sliding contact portion 20 is capable of making a sliding contact with only a part of the side surface of the planetary gear 15, the gear device 5 may have lower rotational resistance of the planetary gear 15 than a configuration in which the sliding contact portion 20 is in contact with the entire side surface of the planetary gear 15 does.

If the sliding contact portion 20 is configured to come into contact with the entire side surface of the planetary gear 15, the sliding contact surface of the sliding contact portion 20 should necessarily have a large area. In addition, in the present embodiment, the worm wheel 12 including the sliding contact portion 20 is made of resin by injection molding.

When the sliding contact surface having a large area is formed by resin molding, it is difficult to ensure high flatness. In addition, since an ejector pin of an injection molding machine must be set at a position corresponding to the side surface of the worm wheel 12, it is difficult to form the sliding contact surface having a large area by resin molding.

In contrast, in the present embodiment, since the sliding contact portion 20 comes into sliding contact only with a part of the side surface of the planetary gear 15, the size of the sliding contact surface can be reduced. Therefore, it is possible to increase the degree of freedom in the arrangement position of the ejector pin and to achieve a high level of flatness of the sliding contact surface.

In addition, the first elongated protrusion 21, out of the first and second elongated protrusions 21 and 22 that constitute the sliding contact portion 20, is located on the side opposite the second elongated protrusion 22 with the trajectory interposed therebetween, the trajectory being traced by the center of rotation of the planetary gear 15.

As a result, in the gear device 5, the size of the sliding surface of each of the first elongated protrusion 21 and the second elongated protrusion 22 can be reduced. Even with the reduced size of the sliding surface, it is possible to restrict a significant inclination of a posture of the planetary gear 15.

In the present embodiment, the sliding contact portion 20 is provided on the side surface of the worm wheel 12. The rotation directions of the worm wheel 12 and the planetary gear 15 are opposite.

Therefore, when a virtual circle is defined as a circle that is centered on a center of revolution and that passes through the center of rotation of the planetary gear 15, the relative velocity of the planetary gear 15 with respect to the sliding contact portion 20 differs significantly between one side and the other side, with the virtual circle interposed therebetween.

Regarding this, the sliding contact portion 20 of the gear device 5 is capable of making a sliding contact with only a part of the side surface of the planetary gear 15. Therefore, compared to a configuration in which the entire side surface of the planetary gear 15 is in sliding contact with the side surface of the worm wheel 12, the rotational resistance of the planetary gear 15 can be reduced.

### Other Embodiments

The internal gear 17 of the above embodiment is integrally formed with the inner wall of the casing cover 72. However, the present disclosure is not limited thereto. That is, in the present disclosure, for example, the internal gear 17 may be configured as a separate component made of a material different from that of the casing cover 72.

The sliding contact portion 20 of the above embodiment is configured as an elongated protrusion protruding toward the planetary gear 15 side. However, the present disclosure is not limited thereto. That is, the present disclosure may be configured as follows.

In other words, the present disclosure may include "a configuration in which an annular shaped groove is provided on the side surface of the worm wheel 12, and an edge on an opening side of the groove functions as the sliding contact portion 20", or "a configuration in which the sliding contact portion 20 is a simple flat surface, and a protrusion that comes in sliding contact with the sliding contact portion 20 is provided on the boss 15B or a groove is provided on the tip surface 15C of the boss 15B."

The sliding contact portion 20 of the above embodiment is configured to include the first elongated protrusion 21 and the second elongated protrusion 22. However, the present disclosure is not limited thereto. That is, for example, in the present disclosure, the sliding contact portion 20 may be formed as a single elongated protrusion.

The sliding contact portion 20 of the above embodiment is configured to come in sliding contact with only a part of the tip surface 15C of the boss 15B. However, the present disclosure is not limited thereto. That is, for example, the present disclosure may include a configuration in which the sliding contact portion 20 comes into sliding contact with a portion other than the boss 15B.

The sliding contact portion 20 of the above embodiment is provided on the side surface of the worm wheel 12. However, the present disclosure is not limited thereto.

In the above embodiment, the vehicle seat of the present disclosure is applied to an automobile. However, the application of the invention disclosed herein is not limited thereto. That is, the present disclosure may also be applied to seats used in other vehicles, such as railroad vehicles, ships/boats, and aircraft, and to stationary seats used at theaters, homes, and so on.

Furthermore, the present disclosure is not limited to the above-described embodiments as long as it conforms to the gist of the disclosure described in the above-described embodiments. Therefore, a configuration may be adopted in which at least two of the above-described embodiments are combined, or in which any of the elements illustrated or described with reference numerals in the above-described embodiments are omitted.

What is claimed is:

1. A gear device configured to transmit a rotational force to a movable portion of a vehicle seat, the gear device comprising:
a sun gear configured to receive a driving force from an electric motor;
a planetary gear configured to revolve and orbit around the sun gear while rotating in mesh with the sun gear;
a holder that supports the planetary gear to allow rotation of the planetary gear and revolution of the planetary gear around the sun gear, the holder being arranged rotatably and coaxially with a rotation center axis of the sun gear;
an internal gear in mesh with the planetary gear;
an output shaft configured to receive a rotational force from the holder to thereby rotate; and
a sliding contact portion that is arranged on a side opposite the holder with the planetary gear interposed between the sliding contact portion and the holder and that is capable of making a sliding contact with only a part of a side surface of the planetary gear, the sliding contact portion having an annular shape centered on the rotation center axis of the sun gear.

2. The gear device according to claim 1,
wherein the planetary gear includes a boss that is provided on a side opposite the holder and that protrudes toward a sliding contact portion side with a center axis of the boss coinciding with a rotation center axis of the planetary gear, and
wherein the sliding contact portion is capable of making a sliding contact with only a part of a tip surface of the boss.

3. The gear device according to claim 2,
wherein the sliding contact portion is formed as an elongated protrusion protruding toward a planetary gear side.

4. The gear device according to claim 3,
wherein the holder includes a shaft portion having a protruding shape and fitting into a shaft hole provided at a center of rotation of the planetary gear, and
wherein the planetary gear is inhibited from falling off the shaft portion in a state of being held between the holder and the sliding contact portion.

5. The gear device according to claim 4,
wherein the sliding contact portion is configured to include at least a first elongated protrusion and a second elongated protrusion that are arranged concentrically, and
wherein the first elongated protrusion is positioned on a side opposite the second elongated protrusion with a trajectory interposed between the first elongated protrusion and the second elongated protrusion, the trajectory being traced by the center of rotation of the planetary gear.

6. The gear device according to claim 1, further comprising:
a worm configured to be rotationally driven by an electric motor; and
a worm wheel in mesh with the worm, the worm wheel being arranged coaxially with the sun gear and connected to the sun gear,
wherein the sliding contact portion is provided on a side surface of the worm wheel.
